(19) United States
(12) Patent Application Publication
(10) Pub. No.: US 2010/0036878 A1
(43) Pub. Date: Feb. 11, 2010

(54) System for Extracting Reduced Information of Multimedia Digital Content and System and Method for Displaying Multiple Content Using Reduced Information

(75) Inventor: Dong Hee Kim, Seoul-city (KR)

Correspondence Address: WILMERHALE/BOSTON, 60 STATE STREET, BOSTON, MA, 02109, US

(73) Assignee: ITOVI INC., Seoul-city (KR)

(21) Appl. No.: 12/254,342

(22) Filed: Oct. 20, 2008

(30) Foreign Application Priority Data
Aug. 8, 2008 (KR) 10-2008-0077782

(51) Int. Cl. G06F 17/30; G06F 15/173; G06F 15/16

(52) U.S. Cl. 707/104.1; 709/224; 709/231; 707/E17.019

(57) ABSTRACT

Disclosed herein is a system for extracting the reduced information of multimedia digital content. The system includes an image variation-related color table database, a volume/tempo variation-related color table database, a default value and environment information database, digital content reduced information extraction means, and storage means. The digital content reduced information extraction means extracts the reduced information of multimedia digital content, which is received when the multimedia digital content, including moving image data, audio data and/or image data. The storage means stores the pieces of reduced information, including thumbnail images, image clips/low-quality images, video clips, audio visualization moving images, audio representative colors, variation-related colors, and image representative colors, which are extracted by the digital content reduced information extraction means.

### CROSS REFERENCE TO RELATED APPLICATION

This application claims benefit of Korean Patent Application No. 10-2008-0077782 filed on Aug. 8, 2008.

### BACKGROUND OF THE INVENTION

1. Field of the Invention

The present invention relates generally to a system for extracting the reduced information of multimedia digital content and a system and method for displaying multiple multimedia content using the reduced information, and, more particularly, to a system for extracting the reduced information of multimedia digital content, which effectively reduces multimedia digital content, such as photographs, music and moving images, such that the multimedia digital content is suitable for the characteristics of multimedia content in an environment of restricted computing power and network bandwidth, and which, when a plurality of pieces of multimedia content is searched for using various media, enables a user to accurately select desired content in a short time through audio-visual determination by effectively using the pieces of reduced information, and a system and method for displaying multiple multimedia content using the reduced information.

2. Description of the Related Art

Generally, the image viewer or a file browser of a personal computer has a function of displaying image files in the form of small-sized images for preview. The function is called thumbnail image browsing.

Therefore, when a user executes a thumbnail image browsing function, images (*.JPG and *.TIF) on which compression has been performed are decoded, the original images thereof are generated, thumbnail images are generated based on the respective original images, and then the thumbnail images are displayed on a screen.

The thumbnail image browsing function has been usefully used for an electronic album used to store and display images taken by a camera, and a user can easily search for desired images using the displayed thumbnail images.

Meanwhile, when a title of a movie is input using a search site, such as an Internet portal site, various types of content relevant to the movie is displayed on a screen. The site provides a screen, which is a representative display type and which includes a list including a thumbnail image and text for describing the details of the movie. In the case of TV channels, the details of all of the channels cannot be viewed at a glance. Even though a function of enabling the details of all of the channels to be viewed is provided, the results of the function merely correspond to a list of still images at specific moments.

This type of interface cannot be considered as an interface which properly shows the characteristics of multimedia digital content. The reason for this is that an interface can be called a multimedia content display interface only when a user can receive impression of the details of multimedia content based on audio-visual determination instead of determining the details of multimedia content through sentences. When the multimedia content display interface is implemented, two problems of a limitation on computing performance and a limitation on network bandwidth arise as restrictions.

In order to implement a multimedia content display interface capable of providing audio-visual impressions to users while solving the two restrictions, what to display and how to display should be considered.

In the case of an Internet Protocol Television (IPTV) and a cable TV which have a plurality of channels, how to provide information about each of the channels to users is a main problem. A method of providing notification using a program table may be one solution, but the current state or details of the channel cannot be provided using the method.

Although there is a method of displaying a plurality of channels on a single screen in the form of thumbnail images, only information about specific moments can be received using the method. A method of playing all channels on a single screen cannot be implemented due to a limitation on the performance of a play device. Therefore, a method capable of displaying the details of a plurality of channels with the lapse of time within limitations on the play device has been required.

Further, in the case of search over the Internet, when a moving image is searched for using a specific title, thumbnail images and the descriptions thereof are displayed on a screen as the results of search. Most of the images and the descriptions thereof, displayed as the results of search, are prepared by a user who uploaded the relevant content. In this case, the images and the descriptions thereof may not match actual images. The images and the descriptions thereof which do not match the actual images may be generated by mistake or intentionally misspelling by the user who uploaded the corresponding images, and such an error causes a significant problem for the reliability of the results of the search. Although the problem may be solved by displaying all the relevant images, it is impossible to display all the relevant images due to limitations on network bandwidth and the computing power of a terminal or a receiver.

Therefore, a method of reducing the details of content in various forms and then displaying the reduced information within a limitation on the performance of given hardware, thereby enabling a user to quickly and accurately select desired content from a list of the results of search, has been required.

Meanwhile, in the case of a Closed-Circuit Television (CCTV) which is connected with a plurality of cameras and configured to receive moving image data, a plurality of channels can be simultaneously viewed at a place, where the CCTV is installed, by increasing the number of physical display devices. However, the plurality of channels cannot be simultaneously viewed on a single screen at a remote place due to a limitation on a network speed. Generally, four channels, and, maximally, 8 channels are provided for a real-time moving image.

The problem of a network speed affects sounds. Most of CCTV cameras do not support audio. The reason for this is that a Motion Joint Photographic Experts Group (MJPEG) format capable of compressing pictures and then transmitting the resulting pictures in a short time has been commonly used due to network bandwidth and CPU power which are not sufficient to transmit the pictures.

Although a high-performance codec, such as H.264, is currently used, video information from which audio is removed is transmitted in most cases because network bandwidth and Central Processing Unit (CPU) power for decoding are restricted. Therefore, a method capable of solving those problems has been required.

Further, in the case in which music is searched for, the image of a performer, a singer or an album jacket is used as a representative image, similar to the case in which a moving image is searched for, and the impression of relevant music is expressed using words and impression of a song and a description related to the performer or the singer. Such a description is used because it is difficult to visually express audio, unlike moving images.

Furthermore, in the case in which there is a plurality of pieces of information corresponding to the results of search, in order to determine whether relevant music is a user's desired music or not, the determination must be performed by reading descriptions or listening to a clip corresponding to a specific part of the music. Therefore, in the case of music, a method of performing not only aural determination but also visual determination, as with a moving image, is required.

Meanwhile, with the rapid popularization of digital cameras, digital photographs have been generalized. With the popularization of devices, capable of taking high-resolution photographs, and large-capacity memory, the number and capacity of digital photograph content possessed by individuals cannot be ignored. A thumbnail image is displayed as the result of search with respect to a several tens of megabyte high-resolution photograph or a several hundreds of megabyte scan image, and a user should determine whether an image is a desired image based on the thumbnail image.

However, there is a case in which it is difficult to detect the details of a photograph only using a small-sized thumbnail image. For example, when a photograph in which a plurality of people is taken together is displayed in the form of a small-sized thumbnail image, it is difficult to detect the people in the picture. If an original photograph is viewed in order to detect the people, operations for transmitting user's intention (for example, operations of moving and clicking a mouse) are required, a time is required to download the original photograph, and various processes, such as movement of the picture on a screen, should be performed. Therefore, a method of effectively searching for and selecting a photograph image has been required.

When Internet portal sites are searched for multimedia content, the results of search are displayed on each of web pages in the form of one or more thumbnail images and text. A user reads description data in order to determine whether the results of search correspond to desired content. If the results of search correspond to the user's desired content, the user clicks a link on a web page using a mouse, moves to a relevant web site including the corresponding content, and then checks the content. If the results of content do not correspond to the user's desired content, the above operations are repeated.

Further, in the case of a CCTV, an Internet Protocol Television (IPTV), or a cable TV, each of which includes a plurality of channels, a method of a user searching for a desired channel includes a method of referring to a program table, a method of switching and checking channels one by one, and a method of checking a list of thumbnails with regard to content, which is currently being taken/broadcasted, and then performing selection.

In the case of a radio, when a desired channel is searched for, the details of broadcasting can be known only when the details of the broadcasting are actually listened to by switching channels with reference to a program table. In the case of the radio, a method of performing search using thumbnails has not been used.

As described above, a conventional mechanism for detecting multiple multimedia contents includes a plurality of steps, requires additional information, is complex, and requires excessive time for determination.

### SUMMARY OF THE INVENTION

Accordingly, the present invention has been made keeping in mind the above problems occurring in the prior art, and an object of the present invention is to provide a system and method for displaying multiple multimedia content, which enables a user to accurately select desired content in a short time through audio-visual determination from among a plurality of pieces of multimedia content, existing in various media such as Internet/CCTV/TV/radio.

Another object of the present invention is to provide a system and method for displaying multiple multimedia content, which uses a plurality of pieces of reduced information of multimedia content, which are extracted based on the characteristics of the multimedia content and which have various formats and qualities, so that a user can select and use the reduced information based on the computing performance of a terminal and network bandwidth.

Another object of the present invention is to provide a determination method of actively detecting the computing performance of a terminal and network bandwidth, thereby determining the most suitable reduced information from among a plurality of pieces of reduced information having various qualities and formats.

Another object of the present invention is to provide a system for displaying multiple (multi-channel) multimedia content for an IPTV or a cable TV, which enables a user to rapidly and accurately detect desired content, and to determine the reduced information of multimedia digital content extracted such that a time point to watch the content can be determined.

Another object of the present invention is to provide a system for displaying multiple multimedia contents, which can display the details of content through various types of reduced information within a limitation on the performance of hardware so that a user can rapidly and accurately select desired content from a list of results of search.

Another object of the present invention is to provide a method of displaying multimedia content, which can display the details of a plurality of channels with the lapse of time using an IPTV or a cable TV, each of which includes a plurality of channels, within a limitation on the performance of a play device.

Another object of the present invention is to provide a system for extracting the reduced information of multimedia digital content, which visually and aurally expresses a distance using the same method as a person's audio-visual detection method, so that a plurality types of reduced information of multimedia content is extracted such that a plurality of pieces of content are detected and desired content is selected using a method which is the most familiar to a person.

Another object of the present invention is to provide a method of displaying the content of a moving image, which enables a CCTV, which receives a plurality of moving images from a plurality of cameras, to simultaneously display a plurality of channels on a single screen using an image clip/audio variation-related color table and a plurality of methods, such as an audio sample extraction method and an audio separation and extraction method.

Another object of the present invention is to provide a method of not only aurally determining but also visually determining results of search, as in the case of a moving image, the results of search being found when music is searched using audio variation-related visualized moving image and visualized moving image clips, and audio variation-related color and representative colors based on volume/tempo variation-related table.

Another object of the present invention is to provide a method of rapidly and accurately selecting thumbnail images, having various resolutions and sizes, and a plurality of partial images for an original image and a reduced image thereof by using a plurality of pieces of reduced information independently or using them after mixing them based on the computing performance of a terminal and network bandwidth.

In order to accomplish the above object, the present invention provides a system for extracting the reduced information of multimedia digital content, including an image variation-related color table database; a volume/tempo variation-related color table database; a default value and environment information database; digital content reduced information extraction means for extracting the reduced information of multimedia digital content, which is received when the multimedia digital content, including moving image data, audio data and/or image data; and storage means for storing the pieces of reduced information, including thumbnail images, image clips/low-quality images, video clips, audio visualization moving images, audio representative colors, variation-related colors, image representative colors, which are extracted by the digital content reduced information extraction means.

The digital content reduced information extraction means includes a content input unit for receiving the multimedia digital content; a content type/detail analysis unit for analyzing the type and format of content when the multimedia digital content is received; a thumbnail image extraction unit for extracting a plurality of thumbnail images in various sizes and resolutions at intervals of f(n) seconds based on an original moving image, and storing the extracted images in the storage means; an image clip/low-quality audio extraction unit for extracting information about various-quality of image clips, each from which audio is removed, low-quality audio, and low-quality audio clips, and then storing the details of the information in the storage means; a video/audio clip generation unit for generating various-quality of movie clips and low-quality movie clips, each of which includes audio and video, and then storing them in the storage means; an image variation detection unit for extracting variation-related colors and representative colors, and then storing them in the storage means; a video bit rate-based encoding unit for generating the various-quality of reduced information of the moving image by encoding the extracted information again using codec information, designated for a default value and environment information, at a bit rate which is lower than that of the original moving image; an image clip/low-quality audio extraction unit for generating low-quality audio data based on original audio, and then storing it in the storage means; a video/audio clip generation unit for generating audio clips and highlights, and then storing them in the storage means 195; an audio visualization moving image generation unit for generating an audio variation-related moving image or partial clips and then storing variation in audio in the storage means; an audio variation detection unit for generating variation-related colors 360 and representative colors with reference to a volume/tempo variation-related color table, and then storing them in the storage means; and a photograph size alteration and partial image generation unit for, if the input content corresponds to a photograph image, generating ‘n’ width×height thumbnail images.

According to another aspect of the present invention, the present invention provides a system for displaying multiple multimedia content, the system providing the reduced information of digital content so that a user can search for desired multimedia content in a short time when the user searches for multimedia digital content using the previously generated reduced information of the multimedia digital content, the system including a plurality of download queues; a plurality of parallel queues and parallel download managers; a queue management policy configured to determine the number of the plurality of parallel queues and parallel download managers, a download speed, and environmental control; a download queue manager configured to vary a method of performing distribution from the download queues to the respective parallel queues based on the queue management policy; a human interface configured to provide a function which enables a user to move, increase, and reduce a viewing area; a memory map configured to store the reduced information so that the display manager performs display on the screen of a display; a memory map manager configured to determine whether the reduced information is appropriately reached at a requested time, and whether the performance of a device and network bandwidth are appropriate to the quality and type of the reduced information at a current state by detecting the play state of the current reduced information displayed in the memory map; download managers configured to download each single piece of reduced information, and then transmit it to the memory map manager using a time required to perform downloading; a transmission rate control policy configured to receive information which is determined by the memory map manager and is used to determine whether the performance of the device and network bandwidth is appropriate to the quality and type of the reduced information at current state, to store a total refresh time required to indicate an entire single level, a refresh interval time required to refresh the single level, and the value of the type of the reduced information, which will be used for each level, and to affect the interval and operation of a timer; the timer affected by the interval and operation based on the transmission rate control policy; and a scan manager configured to use a reference value used to select the pieces of reduced information to be downloaded into one of the respective download queues based on information set in the transmission rate control policy.

Further, a method of displaying multiple multimedia content according to the present invention, including, when a plurality of moving mages is transmitted to a moving image play device and then played thereon over a communication network, dividing the lateral direction of a moving image play area into x portions (x>1), and dividing a vertical direction thereof into y portions (y>1), thereby setting up N thumbnail play areas (N=x×y), each of which has same resolution; mixing the N thumbnails such that they are played through the set-up N thumbnail play areas, and then transmitting the mixed thumbnails to the moving image play device; receiving one piece of the active area information of the N thumbnail play areas from the moving image play device; making setting such that the resolution of an active image corresponding to the active area information is increased at ‘a’ magnification ratio (a>1), and the resolutions of ‘i’ surrounding images (i>1) which are located in the near area of the active area is increased at ‘b’ magnification ratio (1≦b<a), which exists between the resolution of the thumbnail and the resolution of the active image; and mixing the active image, which is increased at the ‘a’ magnification ratio, the ‘i’ surrounding images, each of which is increased at the ‘b’ magnification ratio, and N−(i+1) thumbnails, and then transmitting mixed results to the moving image play device.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram showing the configuration of a system for extracting the reduced information of multimedia digital content according to the present invention;

FIGS. 2A to 2M are views showing various reduced information of a moving image according to an embodiment of the present invention;

FIGS. 3A to 3H are views showing the various pieces of reduced information of audio according to an embodiment of the present invention;

FIGS. 4A to 4E are views showing the various pieces of reduced information of a photograph according to an embodiment of the present invention;

FIG. 5 is a view showing a display and the interface space of the display used for the present invention;

FIG. 6 is a block diagram schematically showing the configuration of a download display system for performing display on the display of a user terminal by utilizing the plurality of pieces of reduced information of multimedia digital content when the multimedia digital content is requested (or searched for) according to the present invention;

FIG. 7 is a view showing the names of the areas of an interface space used for the present invention;

FIG. 8 is a graph showing a method of reducing various pieces of multimedia digital content, and showing the types of content for respective qualities;

FIGS. 9A to 9E are views showing the screen of an interface in which a plurality of pieces of reduced information of multimedia digital content are respectively displayed in a plurality of cells according to the present invention, and the size of each of the cells being increased/reduced depending on the selection of a user; and

FIG. 10 is a view showing a method of performing movement and scrolling on an interface screen according to the present invention.

### DESCRIPTION OF THE PREFERRED EMBODIMENTS

Reference now should be made to the drawings, in which the same reference numerals are used throughout the different drawings to designate the same or similar components.

The extraction of the reduced information of multimedia digital content and the configuration of an interface for multiple multimedia digital contents using the extraction according to an embodiment of the present invention will be described in detail with reference to the attached drawings below.

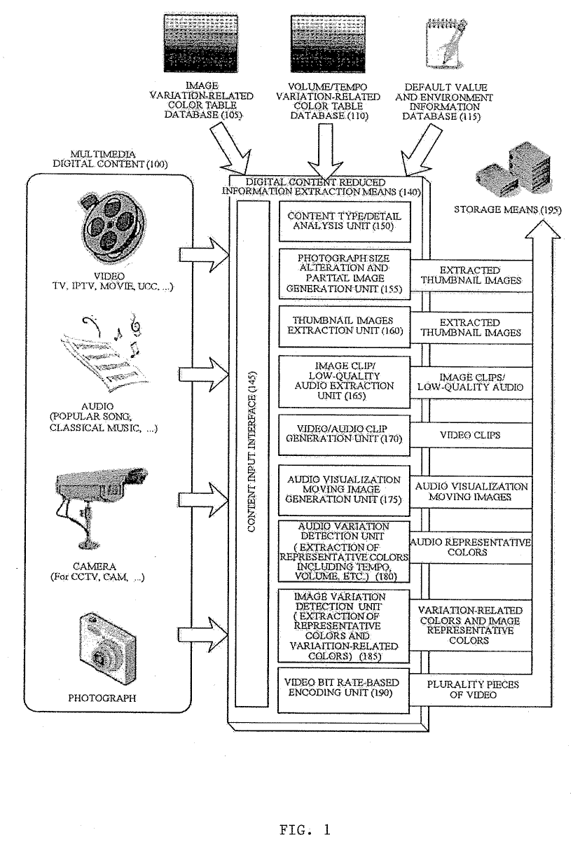

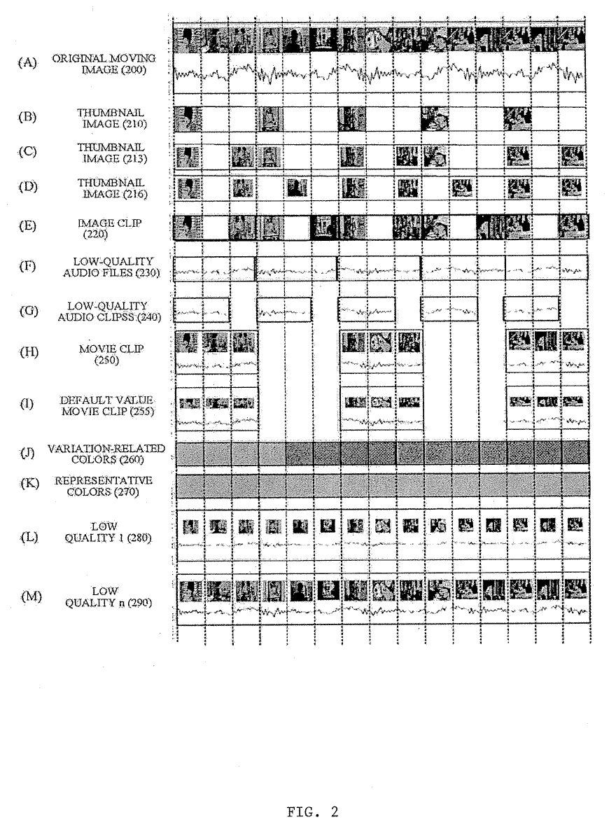

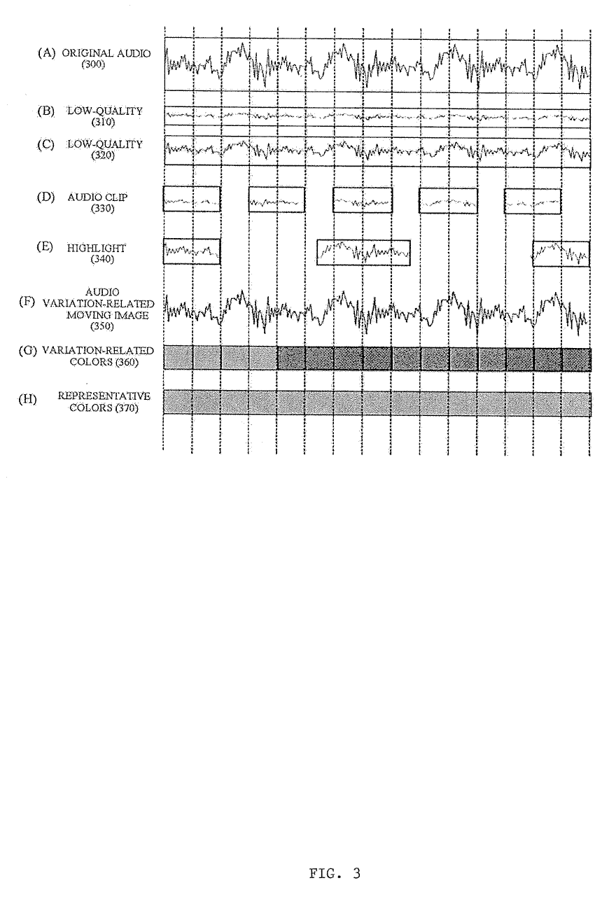

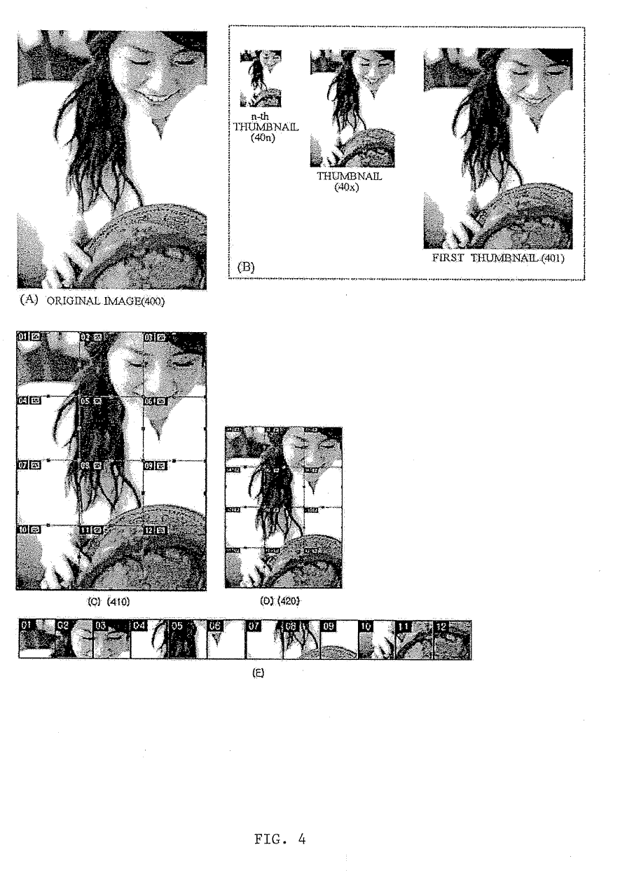

FIG. 1 is a diagram showing the configuration of a system for extracting the reduced information of multimedia digital content according to the present invention. FIGS. 2A to 2M are views showing a process of extracting the reduced information of a moving image and the results of the extraction according to the embodiment of the present invention. FIGS. 3A to 3H are views showing a process of extracting the reduced information of audio and the results of the extraction according to the embodiment of the present invention. FIGS. 4A to 4E are views showing a process of extracting the reduced information of a photograph and the results of the extraction according to the embodiment of the present invention.

When a plurality pieces of multimedia digital content is searched for over the Internet, in order to implement a multiple multimedia content display interface which enables a user to receive impression about the details of the multimedia digital content based on audio-visual determination instead of determining the details of the multimedia digital content based on sentences, a limitation on the computing performance of a terminal and a limitation on network bandwidth should be considered.

Therefore, in order to implement the multiple multimedia content display interface which enables a user to receive audio-visual impression while solving the two limitations, the present invention proposes not existing one or more thumbnail images but a plurality of pieces of various type reduced information of multimedia, which are suitable to the characteristics of multimedia content.

There are a plurality of pieces of reduced information which have various types and qualities, and reduced information which is appropriate to computing performance and network bandwidth is selected and used through the interface. The selection of the reduced information enables acclimation in various network environments in the range of low network bandwidth to high bandwidth, and the various types and qualities of the reduced information enables the reduced information, which is appropriate to each of various performances of devices, to be provided in the range of a low performance computer to a high performance computer.

The present invention divides the types of the multimedia content into a photograph (image) type, a music (audio) type, and a moving image (User Created Content (UCC), IPTV, CCTV, or movie) (video) type, and generates pieces of reduced information which are appropriate to the respective content types.

The reduced information of a moving image includes 1) thumbnail images, having various resolutions and sizes, generated at intervals of f(n) seconds (that is, at intervals of predetermined/variable time), 2) images, each of which is generated at intervals of f(a) seconds for f(m) seconds (where a>m), that is, image clips from which audio is removed, for example, Animated Graphic Interface Format (GIF) and Shockwave Flash (SWF: the movie clips of Flash), 3) audio clips in which only audio parts are generated from the moving image at intervals of f(k) seconds for f(d) seconds (where k>d) while having an f(q) quality, 4) moving image clips, including pieces of audio generated at intervals of f(u) seconds for f(1) seconds (where (u>1) while having an f(aq) audio quality, and including images having an f(vq) quality and resolution (that is, including pieces of audio and images having various resolutions and qualities), 5) image and audio variation-based variation-related colors and representative colors based on an image variation-related color table (refer to reference number “105” of FIG. 1) and a volume/tempo variation-related color table (refer to reference number “110” of FIGS. 1), and 6) a plurality of moving images including audio and video having f(aq) and f(vq) qualities, respectively.

The plurality of pieces of reduced information may be independently used or combined and then used. The qualities of the pieces of reduced information, which are combined and then used, are determined based on network bandwidth and computing power.

The reduced information of audio includes 1) pieces of audio having various levels of qualities, 2) audio clips generated at intervals of f(1) seconds for f(u) seconds (that is, regular/variable time period at regular/variable intervals), 3) reduced photographs for respective specific time points (first, middle, and last portions), 4) audio variation-related visualization moving images and clips, and 5) audio variation-related colors and representative colors based on a volume/tempo variation-related color table. The pieces of reduced information may be used independently or combined and then used. The qualities of the pieces of information, which are combined and then used, are determined based on network bandwidth and computing power.

The reduced information of a photograph includes 1) reduced photographs having various sizes, and 2) f(n) partial images for an original photograph and a reduced photograph. The reduced photographs and the partial images may be independently used or may be combined and then used.

The “f( )” is a function, and the results of the function vary depending on given parameters and the characteristics of content.

Referring to FIG. 1, the system for extracting the reduced information of multimedia digital content according to the present invention includes an image variation-related color table database 105; a volume/tempo variation-related color table database 110; a default value and environment information database 115; a digital content reduced information extraction means 140 for extracting reduced information received when the multimedia digital content (100), including moving image data, audio data and/or image data, is input, the reduced information including the various thumbnail images, image clips/low-quality images, video clips, audio visualization moving images, audio representative colors, various colors, and image representative colors of the multimedia digital content 100; and storage means 195 for storing various pieces of reduced information extracted by the digital content reduced information extraction means 140.

When the multimedia digital content 100, including moving image data which is obtained based on a TV, an IPTV, a CCTV, a Computer Aided Manufacturing (CAM) and a camcorder, and which corresponds to movie and User Created Content (UCC), audio data which corresponds to various songs, classical music and popular songs, and image data which is obtained based on a photograph, is input, the digital content reduced information extraction means 140 includes a content type/detail analysis unit 150, a photograph size alteration and partial image generation unit 155, a thumbnail image extraction unit 160, an image clip/low-quality audio extraction unit 165, a video/audio clip generation unit 170, an audio visualization moving image generation unit 175, an audio variation detection unit 180, an image variation detection unit 185, and a video bit rate-based encoding unit 190.

That is, the digital content reduced information extraction means 140 includes the content input unit 145 for receiving the multimedia digital content 100; the content type/detail analysis unit 150 for analyzing the type and format of the content when the multimedia digital content is received; the thumbnail image extraction unit 160 for extracting a plurality of thumbnail images 210, 213, and 216 in various sizes and resolutions at intervals of f(n) seconds based on an original moving image 200, and for storing the extracted images in the storage means 195; the image clip/low-quality audio extraction unit 165 for extracting information about various-quality of image clips 220 from which audio is removed, low-quality audio files 230, and low-quality audio clips 240, and then storing the details thereof in the storage means 195; the video/audio clip generation unit 170 for generating various-quality of movie clips 250 and low-quality movie clips 255, each of which includes audio and video, and then storing them in the storage means 195; the image variation detection unit 185 for extracting variation-related colors 260 and representative colors 270 and then storing them in the storage means 195; the video bit rate-based encoding unit 190 for generating the various-quality of reduced information of the moving image by encoding the extracted information again using codec information, designated for a default value and environment information, at a bit rate which is lower than that of the original moving image 200; the image clip/low-quality audio extraction unit 165 for generating low-quality audio data 310 and 320 based on original audio 300, and then storing them in the storage means 195; the video/audio clip generation unit 170 for generating audio clips 330 and highlights 340, and then storing them in the storage means 195; the audio visualization moving image generation unit 175 for storing audio variation in the storage means 195 by generating an audio variation-related moving image 350 or partial clips; the audio variation detection unit 180 for generating variation-related colors 360 and representative colors 370 with reference to the volume/tempo variation-related color table 110, and then storing them in the storage means 195; and the photograph size alteration and partial image generation unit 155 for, when the input content corresponds to a photograph image having width ‘W’ (W1, W2, . . . , or Wn) and height ‘H’ (H1, H2, . . . , or Hn), generating ‘n’ W×H thumbnail images (a first thumbnail, a second thumbnail, . . . , and n-th thumbnail) 401 to 40n, the relationship of the size of each of the thumbnail images being Wn<W, . . . , and W1<W, and Hn<H, . . . , and H1<H, based on the original photograph 400.

A process of extracting the reduced information of a moving image, a process of extracting the reduced information of audio, and a process of extracting the reduced information of a photograph, using the system for extracting the reduced information of multimedia content according to the present invention, will be described in detail below.

As shown in FIG. 2, the process of extracting the reduced information of a moving image according to the present invention includes inputting digital content 100 formed by the moving image; analyzing the type and detail of the input digital content 100; if the input digital content corresponds to the moving image 200, extracting f(n) thumbnail images 210, 213, and 216 in various sizes and resolutions for the entire moving image at intervals of f(s) seconds, and then storing them; extracting various-quality of information of the extracted thumbnail images 210, 213, and 216, in which the video and audio are included or from which audio is removed and only video is included, storing them, and then extracting the variation-related colors 260 and representative colors 270 based on the extracted information; generating various-quality of reduced information of the moving image by encoding the extracted information again at a bit rate which is lower than that of the original moving image 200 using codec information designated for default value and environment information; and, when web is searched or a channel is selected, for displaying the reduced information of the moving image in the form any of the thumbnail images 210, 213, and 216, the image clips 220, and the combination of the image clips 220 and the low-quality audio 230 and 240, based on the network of a user terminal and the performance of the terminal.

In detail, when the content 100 is received through the content input unit 145, the content type/detail analysis unit 150 analyzes the type and format of the content.

If, as the results of the analysis of the type and format of the content performed by the content type/detail analysis unit 150, the received content 100 is determined to be a moving image, the thumbnail image extraction unit 160 extracts a plurality of thumbnail images 210, 213, and 216 in various sizes and resolutions at intervals of f(n) seconds based on the entire original moving image 200, as shown in FIGS. 2A to 2D, and then stores the extracted images in the storage means 195.

Thereafter, the image clip/low-quality audio extraction unit 165 extracts information about the various-quality of image clips 220 from which audio is removed, the low-quality audio 230, and the low-quality audio clips 240, as shown in FIGS. 2E to 2G, and then stores the details of the information in the storage means 195.

Further, the video/audio clip generation unit 170 generates various-quality of movie clips 250 and low-quality movie clips 255 each of which includes images and pieces of audio, as shown in FIGS. 2H and 2I, and then stores them in the storage means 195.

Here, the various-quality of movie clips and low-quality movie clips 250 and 255 are stored in the storage means 195 in such a way that f(n) images and f(n) pieces of audio, which are played at intervals of f(s) seconds for f(d) seconds (where s>d), are generated at lower quality than that of the original moving image 200.

Thereafter, the image variation detection unit 185 extracts the variation-related colors 260 and representative colors 270, as shown in FIGS. 2J and 2K, and then stores them in the storage means 195.

Here, colors are made in such a way that color information which is appropriate to variation is extracted with reference to the image variation-related color table 105 and the volume/tempo variation-related color table 110 of FIG. 1.

The representative colors 270 include two types of colors, that is, audio representative colors and image representative colors which represent an entire moving image, and people can detect the activity of images and rapid variation in volume using the colors.

Finally, the video bit rate-based encoding unit 190 generates various-quality of low-quality moving images 280 and 290, as shown in FIGS. 2L and 2M, by performing encoding again at a bit rate which is lower than that of the original moving image 200 using codec information designated for a default value and environmental information 115, and then stores them in the storage means 195.

Here, when web is searched or a channel is selected, the reduced information of a moving image is displayed by extracting the thumbnail image 210 or the image clips 220, or is played by extracting and combining the image clips 220 and the low-quality audio 230 depending on the network of a user terminal or the performance of the terminal.

Therefore, a plurality of images can be displayed on the screen of a user terminal, so that the user can receive impression that the plurality of images is simultaneously played, and can understand overall details. Further, brief details of the movie clips 250 can be viewed by displaying the movie clips 250 while fading them in and out. Here, the user terminal means a computer device such as a personal computer and a notebook computer.

Further, the representative colors 270 allow the impression of a relevant image to be directly/visually determined, and the variation-related colors 260 allow variation in images and pieces of audio to be displayed with the lapse of time using low network bandwidth.

When the user selects a moving image, any one of the original moving image 200 or the low quality moving image, that is, any one of a first low quality moving image 280 to an ‘n’-th low quality moving image 290 can be played depending on the network state of the user terminal or the performance of a computer or a play device.

As shown in FIG. 3, the process of extracting the reduced information of audio according to the present invention includes inputting digital content 100; analyzing the type and details of the input digital content; if the input digital content corresponds to audio 300, generating the reduced information of the audio, which includes low-quality audio data 310 and 320, audio clips 330, highlights 340, an audio variation-related moving image 350 for displaying variation in the audio, variation-related colors 360 and representative colors 370 with reference to a part of clips or the volume/tempo variation-related color table 110; and visually displaying variation in the audio at low bandwidth using the audio variation-related moving image 350 and variation-related colors 360 of the generated the reduced information of the audio.

In further detail, if the content input through the content input unit 145 is determined to be audio by the content type/detail analysis unit 150, the low-quality audio extraction unit of the image clip/low-quality audio extraction unit 165 generates the low-quality audio data 310 and 320, as shown in FIGS. 3B and 3C, and then stores them in the storage means 195.

Further, the video/audio clip generation unit 170 generates the audio clips 330 and the highlights 340, as shown in FIGS. 3D and 3E, and then stores them in the storage means 195.

Thereafter, the audio visualization moving image generation unit 175 generates the audio variation-related moving image 350 or a part of clips for variation in audio, as shown in FIG. 3F, and then stores them in the storage means 195.

Finally, the audio variation detection unit 180 generates the variation-related colors 360 and the representative colors 370 with reference to the volume/tempo variation-related color table 110, as shown in FIGS. 3G and 3H, and then stores them in the storage means 195.

Here, the audio variation-related moving image 350 and variation-related colors 360 of the generated reduced information of the audio enable variation in the audio to be visually viewed at low bandwidth, and the representative colors 370 enable the characteristics of audio to be detected at once.

Further, the low-quality audio data 310 and 320, the audio clips 330, and the highlights 340 enable the details of content to be sufficiently transmitted using low network bandwidth and computing power.

As shown in FIG. 4, the process of extracting the reduced information of a photograph image according to the present invention includes inputting multimedia digital content 100; if, as the results of the analysis of the type and format of the input multimedia digital content, the input content is a photograph image 400 having a width ‘W’ and a height ‘H’, generating ‘n’ thumbnail images (a first thumbnail, a second thumbnail, . . . , and a n-th thumbnail) 401 to 40n; extracting the reduced information of an original image and a reduced image corresponding to the thumbnail images, dividing the original image and the reduced image into width f(x)×height f(y) blocks, and then storing the reduced information; selecting the reduced information in the form of thumbnail images or partial images in appropriate resolutions depending on the network speed and screen resolution of a user terminal and the characteristics of a display device, and then displaying the thumbnail images or partial images sequentially or based on designated or intended order at intervals of f(s) seconds.

In further detail, when the multimedia digital content 100 in the form of a photograph image is input through the content input unit 145 of the digital content reduced information extraction means 140, the content type/detail analysis unit 150 analyzes the type and format of the content.

If, as the results of the analysis, when the input content corresponds to a photograph image having width ‘W’ (W1, W2, . . . , or Wn) and height ‘H’ (H1, H2, . . . , or Hn), the photograph size alteration and partial image generation unit 155 generates ‘n’ W×H thumbnail images (a first thumbnail, a second thumbnail, . . . , and n-th thumbnail) 401 to 40n, the relationship of the size of each of the thumbnail images being Wn<W, . . . , and W1<W, and Hn<H, . . . , and H1<H, as shown in FIG. 4B.

Further, the original photograph 400 and the reduced image are stored in the storage means 195 in such a way that an original partial image 410 and a reduced partial image 420 are respectively divided into f(x)×f(y) blocks, as shown in FIGS. 4C and 4D, f(x) corresponding to width and f(y) corresponding to height.

Here, the values of f(x) and f(y) may vary depending on the size of a photograph, the characteristics of a display device, and definition by a user.

When internet search results and a list of photographs are displayed, the generated reduced information of the photograph image is selected in the forms of thumbnail images 401 to 40n or partial images 410 and 420 in appropriate resolutions depending on the network speed and screen resolution of the user terminal and the characteristics of the display device, and then the thumbnail images 401 to 40n or the partial images 410 and 420 are displayed sequentially or based on designated or intended order, that is, based on an intended display method, at intervals of f(i) seconds, as shown in FIG. 4E.

Here, a method of displaying the thumbnail images 401 to 40n first, and then displaying the partial images 410 and 420 depending on the display intention, that is, a method of using thumbnail images together with partial images may be used.

When the above-described method is used, the user can view an image which has higher resolution than that of thumbnail image without specific control. When an image selected by the user is displayed, images, which are the most appropriate to a user environment, a device, and the restricted state of a network, are selected and then transmitted, so that an optimum image can be viewed in a short time.

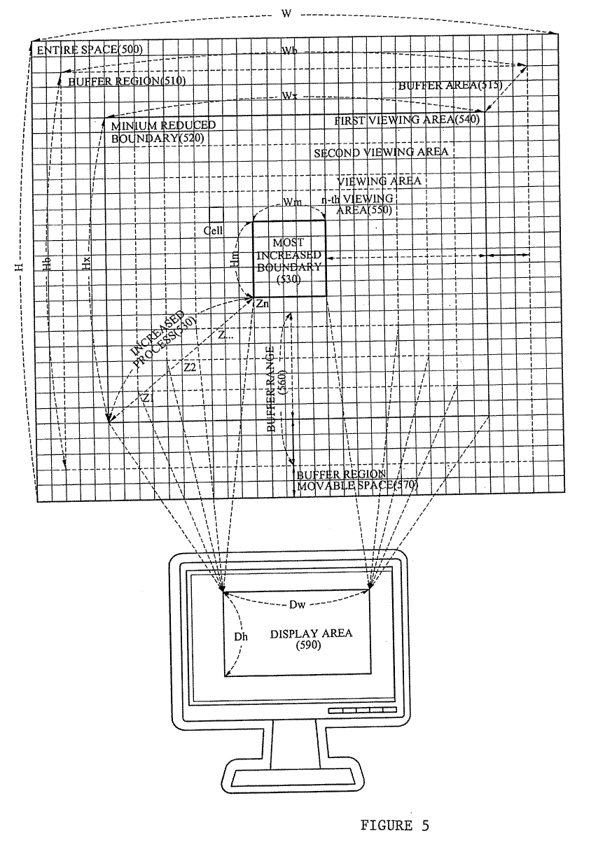

As described above, the present invention configures the system for extracting reduced information as shown in FIG. 1, so that the reduced information of multimedia digital content is extracted, and then the information can be displayed and selected in an interface space shown in FIG. 5.

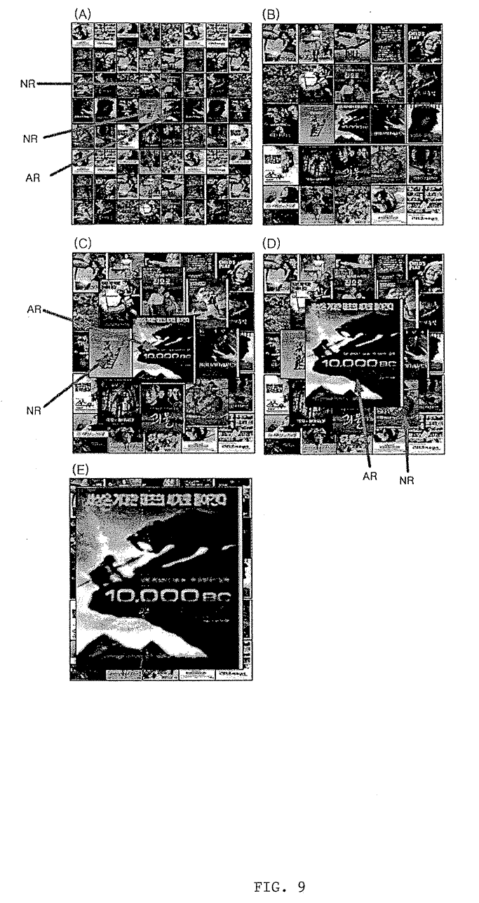

The generated information is used in the type of an interface shown in FIG. 9 in the interface space shown in FIG. 5.

The space used by the interface is shown in FIG. 5. First, various pieces of reduced information, each indicating a piece of content, are displayed on respective single cells. The size of each of the cells is increased or reduced based on the selection of the user.

An entire space 500 is a two-dimensional space which has W×H pieces of content arranged in a rectangular form, ‘W’ corresponding to a width and ‘H’ corresponding to a height. A buffer region 510 is larger than a viewing area 540, which is viewed currently, by a buffer area 515. When the viewing area corresponds to a first viewing area 540, the size thereof is (Wb×Hb)(Wx×Hx) and this area is a space on which buffering is performed. As the viewing area varies, the size of the buffer area 515 varies.

All the viewing areas are included in the predetermined area of the display area 590. The minimum reduced boundary 520 corresponds to an area in which a largest number of cells are displayed on a single screen while each having the most minimized size, when a user reduces a screen which is being viewed. The most increased boundary 530 corresponds to an area in which a smallest number of cells are displayed while each having the largest size, when the user increases the screen.

That is, when a largest number of cells are displayed on the display area 590, Wx×Hx cells, which correspond to the minimum reduced boundary 520, are displayed. When a smallest number of cells are displayed, Wm×Hm cells, which correspond to the most increased boundary 530, are displayed.

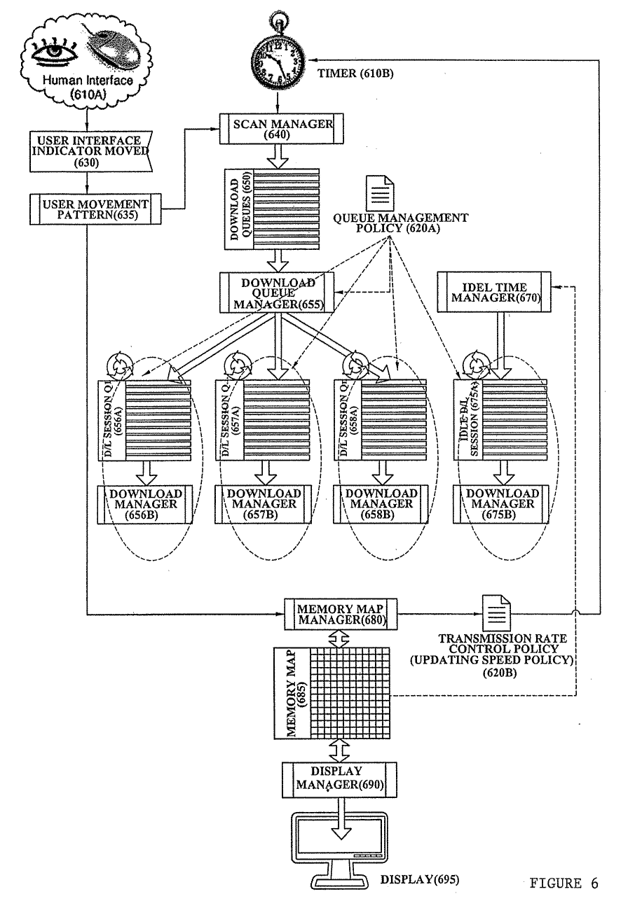

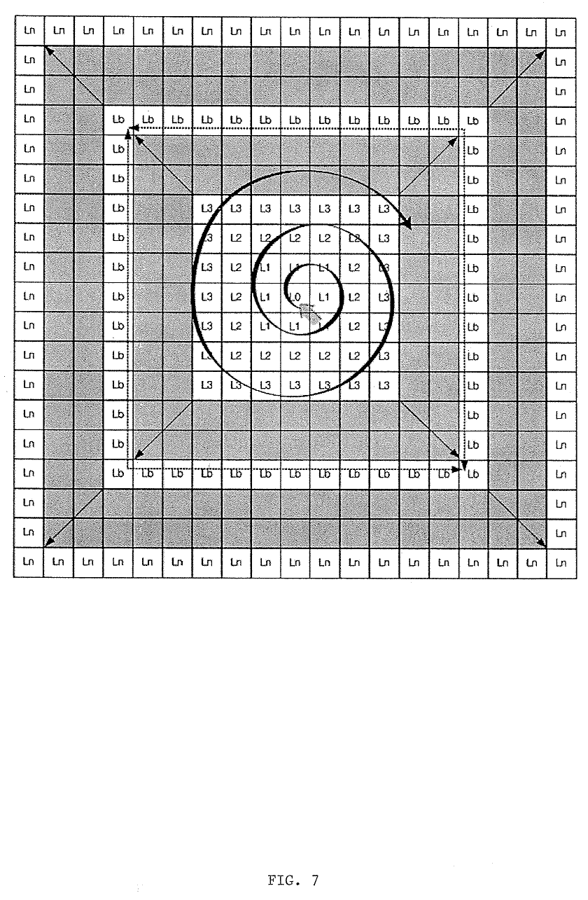

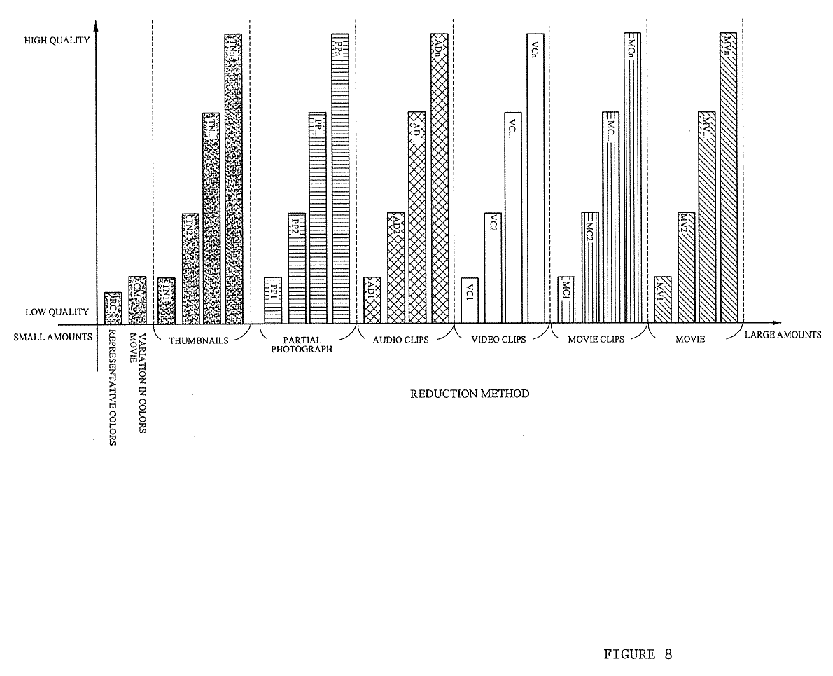

FIG. 6 is a block diagram schematically showing the configuration of a system for displaying multiple multimedia content, which is used to display a plurality of pieces of reduced information of the multimedia digital content on the display of a user terminal when the multimedia digital content is requested (or searched for) according to the present invention. FIG. 7 is a view showing the names of the areas of an interface space used in the present invention. FIG. 8 is a graph showing a method of reducing various pieces of multimedia digital content, and showing the types of content for respective qualities. FIGS. 9A to 9E are views showing the screen of an interface in which a plurality of pieces of reduced information of multimedia digital content are respectively displayed in a plurality of cells according to the present invention, and the size of each of the cells being increased/reduced depending on the selection of a user.

In order to implement a user interface by displaying the reduced information of digital content in a plurality of cells, as shown in FIG. 9, in the interface space of FIG. 5, a system for displaying multiple multimedia digital content, shown in FIG. 6, is used.

With reference to FIG. 6, the system for displaying multiple multimedia digital content, which provides the reduced information of digital content so that a user can search for desired multimedia content in a short time when the user searches for multimedia digital content using the previously generated reduced information of multimedia digital content will be described.

Referring to FIG. 6, the system for displaying multiple multimedia digital content according to the present invention includes a plurality of queues 650; a plurality of parallel queues 656A to 658A and 675A and parallel download managers 656B to 658B and 675B; a queue management policy 620A configured to determine the number of the plurality of parallel queues 656A to 658A and 675A and parallel download managers 656B to 658B and 675B, a download speed, and environmental control; a download queue manager 655 configured to vary a method of performing distribution from the download queues 650 to the respective plurality of parallel queues based on the queue management policy, a human interface 610A configured to provide a function which enables a user to move, increase, and reduce a viewing area; a memory map 685 configured to store reduced information so that the display manager 690 performs display on the screen of a display 695; a memory map manager 680 configured to determine whether the reduced information is appropriately reached at a requested time, and whether the performance of a device and network bandwidth are appropriate to the quality and type of the reduced information at a current state by detecting the play state of the current reduced information displayed in the memory map 685; download managers 656B to 658B configured to download each single piece of reduced information, and then transmit it to the memory map manager 680 using a time taken for downloading; a transmission rate control policy 620B configured to receive information which is determined by the memory map manager 680 and is used to determine whether the performance of the device and network bandwidth is appropriate to the quality and type of the reduced information at current state, to store a total refresh time required to indicate an entire single level, a refresh interval time required to refresh a single level, and the value of the type of the reduced information, which will be used for each level, and to affect the interval and operation of a timer; the timer 610B affected by the interval and operation based on the transmission rate control policy, and a scan manager 640 configured to use a reference value used to select the pieces of reduced information to be downloaded into the respective download queues 650 based on the information set in the transmission rate control policy 620B.

Further, the system for displaying multiple multimedia digital contents further includes an idle time manager 670 configured to cache content which will be necessary in the future when the user does not provide any input and stops, thereby improving a response speed for the user.

The system for displaying multiple multimedia digital contents will be described in detail below.

The system dynamically detects the computing performance and network bandwidth of a terminal, and then determines the most appropriate reduced information from among reduced information in various qualities and formats.

The system includes the parallel queues 656A to 658A and 675A and the parallel download managers 656B to 658B and 675B. The number of queues and download managers 656A to 658A and 675A and 656B to 658B and 675B, a download speed, and an environment vary depending on the queue management policy 620A. Further, a method of performing distribution from the download queue manager 655 to the respective queues varies based on the queue management policy 620A.

Each of the download managers 656B to 658B and 675B downloads a single piece of reduced information, and then transmits it to the memory map manager 680 by using a time taken for downloading. The memory map manager 680 determines whether the reduced information is appropriately reached at a requested time, and whether the performance of a device and network bandwidth are appropriate to the quality and type of the reduced information at current state by detecting the play state of the current reduced information displayed in the memory map 685. The determined information is stored in the transmission rate control policy 620B.

The transmission rate control policy 620B includes a total refresh time which is a total time required to display an entire single level, such as the level L1 (eight) or the level L2 (sixteen) of an area (of FIG. 7), and a refresh interval time required to refresh an entire single level, and the value of the type of the reduced information to be used for each level (refer to FIG. 8).

If, as the results of the measurement, the network bandwidth and the performance of a device are low, the value of the total refresh time is increased and then the state is measured. If the network bandwidth and the performance of a device do not become better, the refresh interval time is adjusted such that the update interval is increased based on a difference in levels. If the network bandwidth and the performance of a device do not become better, the quality and format of the reduced information is caused to be low. In the worst case, all pieces of reduced information, displayed on a screen, correspond to only the thumbnail images 210, 213, and 216. If the performance and network bandwidth are in the best state, a high quality moving image is displayed on the area corresponding to the level L0 (of FIG. 7), and a moving image, the quality of which is a little lower than the high quality moving image, is displayed on the area corresponding to the level L1 (of FIG. 7).

In most cases, with the middle level of network bandwidth and performance, low-quality moving image is located at the area corresponding to the level L0 (of FIG. 7), the reduced information, with which pieces of audio and movie clips 250 are combined, is located at the area corresponding to the level L1 (of FIG. 7), and thumbnail images, the refresh intervals of which are long, are located at remaining areas.

The transmission rate control policy 620B, having the three values, affects the interval and operation of the timer 610B, and the scan manager 640 uses a reference value used to select reduced information which will be downloaded in the download queue 650.

The human interface 610A provides a function which enables a user to move, increase, and reduce the viewing area, and variation in a screen attributable to the movement, increase and reduction of the viewing area is transmitted to the memory map manager 680 through a user interface 630 and the detection of user movement pattern 635. The memory map manager 680 operates in conjunction with the download managers 656B to 658B and 675B, and performs adjustment such that one or more pieces of reduced information, which are generated due to the movement and are not necessary, are not downloaded.

The first priority of download is the viewing area 540. If the network bandwidth and the computing performance are sufficient, buffering is performed on the buffer region 510. If the user does not provide any input and stops, the idle time manager 670 caches one or more pieces of content which will be necessary in the future and improves a response speed for the user. The details of the memory map 685 are displayed on the screen of the display 695 by the display manager 690, as shown in FIGS. 9A to 9E.

Thereafter, the method of displaying multiple moving images using the system for displaying multiple multimedia digital contents according to the present invention will be described in detail below.

When a plurality of moving images is transmitted to a moving image play device over a communication network and then played therein, the method of displaying multiple moving images according to the present invention divides the lateral direction of a moving image play area into x portions (x>1), and divides the vertical direction thereof into y portions (y>1), thereby setting up N thumbnail play areas (N=x×y), each of which has the same resolution (In the case of FIG. 9, N=8×8).

Thereafter, the N thumbnails are mixed such that they are played through the set-up N thumbnail play areas, and then the mixed thumbnails are transmitted to the moving image play device.

When a single piece of Active area (AR) information, included in the N thumbnail play areas, is received from a moving image play device based on the selection of a user, setting is made such that the resolution of an active image corresponding to the AR information is increased at ‘a’ magnification ratio (a>1), and the resolutions of ‘i’ surrounding images (i>1) (in the case of FIG. 9, i=8) which are located in the Near area (NR) of the AR is increased at ‘b’ magnification ratio (1≦b<a) which exists between the resolution of the thumbnail and the resolution of the active image.

The active image, which is increased at ‘a’ magnification ratio, and the ‘i’ surrounding images, each of which is increased at ‘b’ magnification ratio, and N−(i+1) thumbnails are mixed and then transmitted to the moving image play device and displayed thereon (refer to FIGS. 9A to 9E).

It is preferable that the N thumbnail play areas do not exceed a communication speed of the communication network and a maximum value capable of transmitting the thumbnails by one-time speed and then playing them in correspondence with the moving image play resources (process resources and memory resources) of the moving image play device.

Further, it is preferable that the N thumbnails be set such that the play speed of the video data and audio data is set to one-time speed.

Further, it is preferable that the N thumbnails be generated in such a way that the play speed of the video data is reduced to a predetermined ratio in correspondence with the communication speed of the communication network and the moving image play resources of the moving image play device.

The active image is set in such a way that the play speed of the video data and audio data is set to one-time speed.

Further, it is preferable that the ‘i’ surrounding images and the N−(i+1) thumbnails be generated in such a way that the play speed of the video data be reduced in proportion to a distance from the active image. Furthermore, it is preferable that the ‘i’ surrounding images and the N−(i+1) thumbnails be reduced in such a way that the volume of the audio data be reduced (or muted) in proportion to the distance from the active image.

Meanwhile, the type of the operation between an interface and a user in the multiple multimedia digital content display, shown in FIGS. 9A to 9E, is the same as in the case of the plurality of areas corresponding to the levels L0 to Ln shown in FIG. 7. The area corresponding to the level L0 is a cell selected by a user, and this portion shows large amounts of content (for example, reduction method and content for each quality, refer to FIG. 8) which can be realized using the performance of a current user device and network bandwidth. When the area corresponding to the level L0 is selected, the area corresponding to the level L0 is slightly increased, and the area corresponding to the level L1 around the area corresponding to the level L0 starts to be increased.

The increase ratio of the area corresponding to the level L0 is larger than that of the area corresponding to the level L1. As a result, the area corresponding to the level L0 is increased at the largest ratio, and the area corresponding to the level L1 is increased less than the area corresponding to the level L0 but larger than the area corresponding to the level L2. In the case of sound, the sound of the area corresponding to the level L0 is the largest, and the sum of the sound of the area corresponding to the level L1 around the area corresponding to the level L0 is smaller than that of the area corresponding to the level L0.

For example, the area corresponding to the level L0 occupies 80% of entire sound, and the area corresponding to the level L1 has values, each obtained by dividing the remaining 20% by 8. That is, the screen and sound of content selected by the user are large, and the screen and sound of content existing around it are smaller than those of the content selected by the user.

A plurality of areas corresponding to the levels L0 to Ln, shown in FIG. 7, shows the interface. If a user selects a particular piece of content of interest, a relevant image can be viewed through a further large screen and sound of 100%.

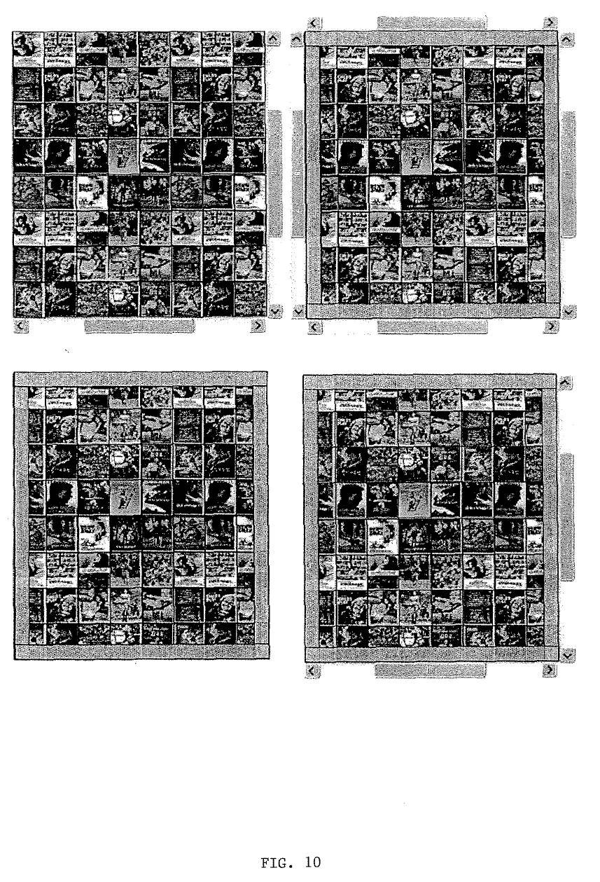

The movement on an entire area and a viewed area is performed using a scrolling method, as shown in FIG. 10. That is, if the user moves to an edge area in upper, lower, right and left edge portions, scrolling is performed. If the user stops at a specific space, the user can move to the upper, lower, right, and left edge portions at a rapid speed. In addition, the movement can be performed using a scroll bar existing on the upper, lower, right, and left edge portions rather than the above-described method.

As described above, the reduced information of multimedia digital content and the user interface, which are obtained through the present invention, enable a user to search for desired multimedia content in a short time within the limited performance of a device and network bandwidth.

Further, the present invention can extract the reduced information of multimedia in various types and qualities which are appropriate to the characteristics of multimedia content and select and use pieces of reduced information which are appropriate to the computing performance of a terminal and network bandwidth. As a result, such selection enables adaptation in various network environments in the range of low network bandwidth to high bandwidth, and various pieces of reduced information and qualities enable reduced information which is appropriate to each of devices, having various performances, for example, computers in the range of low performance to high performance.

The present invention will be used as a solution for searching for multiple (multi-channel) multimedia digital contents and detecting the details thereof, and the present invention can be utilized in various types, such as a channel selection interface, such as an IPTV or CCTV, and a method of encoding a camera for a CCTV.

As described above, the present invention provides a method of displaying optimum reduced information within a limitation on network bandwidth, a limitation on computing power, and restricted performances of various devices, and of utilizing the pieces of reduced information independently or mixing and then utilizing them, and the present invention provides an interface capable of enabling a user to easily and rapidly determine the extracted reduced information of multimedia digital content through audio-visual stimulation of a person, so that the user can rapidly and accurately detect desired content and determine a time point to view the content.

As described above, the present invention provides a method of using a plurality of pieces of reduced information of multimedia digital content generated according to the present invention, and provides a user interface capable of searching for user's desired multimedia content in a short time within the limited performance of a device and network bandwidth.

These methods will be used as new methods of searching for digital content and detecting the details thereof, and can be utilized in various types, such as a channel selection interface, such as an IPTV or CCTV, and a method of encoding a camera for a CCTV.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A system for extracting reduced information of multimedia digital content, comprising:
an image variation-related color table database;
a volume/tempo variation-related color table database;
a default value and configuration information database;
digital content reduced information extraction means for extracting reduced information of multimedia digital content, which is received when the multimedia digital content, including moving image data, audio data and/or image data; and
storage means for storing the pieces of reduced information, including thumbnail images, image clips/low-quality images, video clips, audio visualization moving images, audio representative colors, variation-related colors, and image representative colors, which are extracted by the digital content reduced information extraction means.

2. The system as set forth in claim 1, wherein the digital content reduced information extraction means comprises:
a content input unit for receiving the multimedia digital content;
a content type/detail analysis unit for analyzing type and format of content when the multimedia digital content is received
a thumbnail image extraction unit for extracting a plurality of thumbnail images in various sizes and resolutions at intervals of f(n) seconds based on an original moving image, and storing the extracted images in the storage means;
an image clip/low-quality audio extraction unit for extracting information about various-quality of image clips, each from which audio is removed, low-quality audio, and low-quality audio clips, and then storing details of the information in the storage means;
a video/audio clip generation unit for generating various-quality of movie clips and low-quality movie clips, each of which includes audio and video, and then storing them in the storage means;
an image variation detection unit for extracting variation-related colors and representative colors, and then storing them in the storage means;
a video bit rate-based encoding unit for generating the various-quality of reduced information of the moving image by encoding the extracted information again using codec information, designated for a default value and configuration information, at a bit rate which is lower than that of the original moving image;
an image clip/low-quality audio extraction unit for generating low-quality audio data based on original audio, and then storing it in the storage means;
a video/audio clip generation unit for generating audio clips and highlights, and then storing them in the storage means;
an audio visualization moving image generation unit for generating an audio variation-related moving image or partial clips and then storing variation in audio in the storage means;
an audio variation detection unit for generating variation-related colors and representative colors with reference to a volume/tempo variation-related color table, and then storing them in the storage means; and
a photograph size alteration and partial image generation unit for, if the input content corresponds to a photograph image, generating ‘n’ width×height thumbnail images.

3. The system as set forth in claim 2, wherein the various-quality of movie clips and low-quality movie clips are stored in the storage means in such a way that f(n) images and f(n) pieces of audio, which are played at intervals of f(s) seconds for f(d) seconds (where s>d) are generated in lower qualities than that of the original moving image.

4. The system as set forth in claim 2, wherein:
the variation-related colors enable extract color information, which is appropriate to variation, with reference to the image variation-related color table and the volume/tempo variation-related color table, and display variation in the images and pieces of audio at low network bandwidth with lapse of time; and
the representative colors enable activity of the images and rapid variation in the volume to be detected through audio representative colors and image representative colors, which represent the entire moving image.

5. The system as set forth in claim 2, wherein the encoding is performed again using the codec information designated for the default value and the configuration information at the bit rate lower than that of the original moving image, and a plurality of low-quality moving images is generated and then stored in the storage means.

6. The system as set forth in claim 2, wherein, when web is searched or a channel is selected, the reduced information of the moving image is displayed by extracting the thumbnail images or extracting the image clips, or played by combining the image clips and the low-quality audio based on a network of a user terminal and a performance of the terminal.

7. The system as set forth in claim 2, wherein, when a user selects the moving image, any one of the original moving image or the plurality of low-quality moving images is played based on a network state of a user terminal and a performance of a computer or a play device.

8. The system as set forth in claim 7, wherein the user terminal indicates a computer device including a personal computer and a notebook computer.

9. The system as set forth in claim 2, wherein brief details can be viewed by fading the movie clips in and out.

10. The system as set forth in claim 2 wherein:
an original photograph and a reduced image are stored in the storage means in such a way that an original partial image and a reduced partial image are respectively divided into f(x)×f(y) blocks, and then the resulting blocks are stored in the storage means;
when Internet search results and a list of photographs are displayed, the generated reduced information of the photograph is used to select thumbnail images and partial images, having appropriate resolutions, based on a network speed of a user terminal, screen resolution, and characteristics of a display device; and
the thumbnail images or the partial images are displayed sequentially or based on a designated or intended order at intervals of f(i) seconds.

11. A system for displaying multiple multimedia content, the system providing reduced information of digital content so that a user can search for desired multimedia content in a short time when the user searches for multimedia digital content using previously generated reduced information of the multimedia digital content, the system comprising:
a plurality of download queues;
a plurality of parallel queues and parallel download managers;
a queue management policy configured to determine a number of the plurality of parallel queues and parallel download managers, a download speed, and configuration control;
a download queue manager configured to vary a method of performing distribution from the download queues to the respective parallel queues based on the queue management policy;
a human interface configured to provide a function which enables a user to move, increase, and reduce a viewing area;
a memory map configured to store the reduced information so that the display manager performs display on a screen of a display;
a memory map manager configured to determine whether the reduced information is appropriately reached at a requested time, and whether a performance of a device and network bandwidth are appropriate to quality and type of the reduced information at a current state by detecting a play state of the current reduced information displayed in the memory map;
download managers configured to download each single piece of reduced information, and then transmit it to the memory map manager using a time required to perform downloading;
a transmission rate control policy configured to receive information which is determined by the memory map manager and is used to determine whether the performance of the device and network bandwidth is appropriate to the quality and type of the reduced information at current state, to store a total refresh time required to indicate an entire single level, a refresh interval time required to refresh the single level, and a value of a type of the reduced information, which will be used for each level, and to affect interval and operation of a timer;
the timer affected by the interval and operation based on the transmission rate control policy; and
a scan manager configured to use a reference value used to select the pieces of reduced information to be downloaded into one of the respective download queues based on information set in the transmission rate control policy.

12. The system as set forth in claim 11, further comprising an idle time manager configured to cache content which will be necessary in future when the user does not provide any input and stops, thereby improving a response speed for the user.

13. The system as set forth in claim 11, wherein, if, as a result of measurement, the network bandwidth and the performance of the device are low, the transmission rate control policy is performed in such a way that a value of the total refresh time is increased and then a state is measured, if the network bandwidth and the performance of a device do not become better, the refresh interval time is adjusted such that an update interval is increased based on difference in the levels, and, if the network bandwidth and the performance of a device does not become better, the quality and format of the reduced information is low.

14. The system as set forth in claim 11, wherein, when variation in the screen attributable to movement, increase, and reduction of the viewing area of the human interface is received, the memory map manager operates in conjunction with the download managers, and performs adjustment such that one or more pieces of reduced information, which are generated due to the movement and are not necessary, are not downloaded.

15. The system as set forth in claim 11, wherein first priority of the downloading is the viewing area, and, if the network bandwidth and computing performance are sufficient, buffering is performed on a buffer region.

16. The system as set forth in claim 11, wherein the reduced information comprises one or more thumbnail images, image clips/low-quality images, video clips, audio visualization moving images, audio representative colors, variation-related colors, and image representative colors.

17. The system as set forth in claim 1, wherein the reduced information is obtained by extracting f(n) thumbnails at intervals of f(s) seconds based on the entire moving image.

18. The system as set forth in claim 11, wherein the reduced information is generated in an image clip form (from which audio is removed) by extracting thumbnails from the moving image at an f(p) Frame Per Second (FPS) speed at intervals of f(s) seconds for f(d) seconds.

19. The system as set forth in claim 11, wherein f(n) moving image clips (extracted at an f(p) FPS speed) or f(n) audio clips are extracted for each service bandwidth from the entire moving image and the audio at intervals of f(s) seconds for f(d) seconds at a bit rate lower than that of the original moving image.

20. The system as set forth in claim 11, wherein only audio clips are extracted from the moving image at intervals of f(s) seconds for f(d) seconds.

21. A method of displaying multiple multimedia contents, comprising:
when a plurality of moving images is transmitted to a moving image play device and then played thereon over a communication network, dividing a lateral direction of a moving image play area into x portions (x>1), and dividing a vertical direction thereof into y portions (y>1), thereby setting up N thumbnail play areas (N=x×y), each of which has same resolution;
mixing the N thumbnails such that they are played through the set-up N thumbnail play areas, and then transmitting the mixed thumbnails to the moving image play device;
receiving one piece of active area information of the N thumbnail play areas from the moving image play device;
making setting such that a resolution of an active image corresponding to the active area information is increased at ‘a’ magnification ratio (a>1), and a resolutions of ‘i’ surrounding images (i>1) which are located in a near area of the active area is increased at ‘b’ magnification ratio (1≦b<a), which exists between a resolution of the thumbnail and the resolution of the active image; and
mixing the active image, which is increased at the ‘a’ magnification ratio, the ‘i’ surrounding images, each of which is increased at the ‘b’ magnification ratio, and N−(i+1) thumbnails, and then transmitting mixed results to the moving image play device.

22. The method as set forth in claim 21, wherein the N thumbnail play areas do not exceed a communication speed of a communication network and a maximum value capable of transmitting the thumbnails by one-time speed and then playing them in correspondence with the moving image play resources (process resources and memory resources) of the moving image play device.

23. The method as set forth in claim 21, wherein the N thumbnails are set such that a play speed of the video data and audio data is set to one-time speed.

24. The method as set forth in claim 21, wherein the N thumbnails are generated in such a way that a play speed of the video data is reduced to a predetermined ratio in correspondence with the communication speed of a communication network and the moving image play resources of the moving image play device.

25. The method as set forth in claim 21, wherein the active image is set in such a way that a play speed of the video data and audio data is set to one-time speed.

26. The method as set forth in claim 21, wherein the ‘i’ surrounding images and the N−(i+1) thumbnails are generated in such a way that a play speed of the video data is reduced in proportion to a distance from the active image

27. The method as set forth in claim 21, wherein the ‘i’ surrounding images and the N−(i+1) thumbnails are generated in such a way that a volume of the audio data is reduced (or muted) in proportion to a distance from the active image.

28. A computer-readable recording medium recording a program for executing the method of claim 21.
